(19) United States
(12) Patent Application Publication
(10) Pub. No.: US 2025/0286231 A1
(43) Pub. Date: Sep. 11, 2025

(54) Bus bar for contacting of battery cells accommodated in a cell holder, battery module arrangement and method for connecting a bus bar to a battery cell

(71) Applicant: Webasto SE, Stockdorf (DE)

(72) Inventors: Sebastian Stoll, Stockdorf (DE); Hans Beyer, Stockdorf (DE); Volker Böhringer, Stockdorf (DE)

(21) Appl. No.: 18/562,667

(22) PCT Filed: May 25, 2022
(86) PCT No.: PCT/EP2022/064310

§ 371 Date: May 31, 2024

(30) Foreign Application Priority Data
May 25, 2021 (DE) 10 2021 113 487.0
May 3, 2022 (EP) 22 171 473.6

(51) Int. Cl. H01M 50/503; B60L 50/64; H01M 50/213; H01M 50/516

(52) U.S. Cl. CPC H01M 50/503; H01M 50/213; H01M 50/516; B60L 50/64; H01M 2220/20

(57) ABSTRACT

The present invention relates to a bus bar (1) for contacting preferably cylindrical battery cells (3) accommodated in a cell holder (2) to form a battery module (100) of a high-voltage battery, preferably of a traction battery for a vehicle, comprising a base body (4) extending in a main direction of extent (7) and at least one contacting connector (5, 5′), designed as a single piece with the base body (4), for contacting a cell contact (6) of one of the battery cells, wherein the contacting connector (5, 5′) extends in a connecting direction of extent (8, 8′) which encloses a connecting angle (α) with the main direction of extent (7) of between 0° and less than 90°; it moreover relates to a battery module arrangement (100) with such a bus bar (1) and to a method for connecting a bus bar (1) to a cell contact (6, 6′).

### FIELD OF THE INVENTION

The present invention relates to an improved bus bar for contacting (for example, cylindrical) battery cells accommodated in a cell holder in order to form a battery module of a high-voltage battery, for example of a traction battery for a vehicle, and to a corresponding battery module arrangement for forming a high-voltage battery, for example a traction battery for a vehicle, and to a method for connecting a bus bar to a cell contact of a battery cell in a battery module arrangement.

PRIOR ART

High-voltage batteries, the battery cells of which are connected by bus bars, also known as current collectors, are known from the prior art. The batteries are also referred to as storage batteries. They are generally electrochemical storage batteries, in particular lithium-ion storage batteries. Such batteries usually do not have a monobloc construction and instead are constructed modularly from a plurality of battery cells which are connected to one another mechanically and electrically. It is correspondingly known for the structure of a battery system in an electric vehicle to arrange battery cells in battery modules and to assemble the latter to form a battery. This increases the configurability of batteries and enables the use of relatively cost-effective standard battery cells in the construction of batteries. The battery cells of a battery module can be accommodated by a cell holder. The latter is a body, extending in a plane of extent, which is generally manufactured from a non-conductive material such as plastic and which generally comprises a plurality of sockets, arranged on the plane of extent in a predetermined pattern, for receiving a battery cell.

A battery cell is understood within the sense of the present disclosure to be an electrochemical storage cell, preferably a secondary cell. The term “cell” can be understood as the smallest contactable structural unit in terms of the physical manifestation of the component. In contrast, a battery module is understood to be a structural unit which combines a plurality of battery cells. A battery is correspondingly understood to be a structural unit which is constructed from one or more interconnected battery modules. Such batteries can comprise a housing which receives the battery modules, electrical circuits, and a battery management system. A plurality of batteries can be interconnected to form a battery system in order to provide, for example, an increased capacity of the battery system.

The battery or the battery system are preferably provided for use in an electric vehicle but can also be used in other vehicles or other fields of application.

It is furthermore known from the prior art that if bus bars are welded directly to battery cells, bus bars are correspondingly preformed so that those sections of the bus bar which are provided for connection to the cells touch the cells in order to be able to be welded to the latter. The preforming is an additional manufacturing step because, after a two-dimensional preform of the bus bar has been stamped or cut from a piece of sheet metal, this preform needs to be brought into a three-dimensional shape in a further shaping step, for example a deep-drawing or bending step.

In such bus bars, contacting connectors in the form of so-called tabs which extend three-dimensionally away from an elongated base body of the bus bar, are welded directly to the cell contact to be contacted of the respective battery cell usually by means of ultrasound or laser welding. These tabs conventionally extend perpendicularly to the main direction of extent of the base body of the bus bar, which generally corresponds to a main load direction or a main load path and in which a plurality of battery cells arranged one behind the other are interconnected in parallel via the bus bar. In the case of cylindrical battery cells, the tabs for contacting the positive terminal of the battery cells extend at a 90° angle radially from the base body to the center of that end side of the cylindrical battery cell which has the positive terminal there. In order to contact the negative terminal, they usually run at a 90° angle from the base body tangentially to the flanged edge of that end side of the cylindrical battery cell which has the negative terminal there.

A battery module arrangement with a conventional bus bar with contacting connectors extending perpendicularly from a base body can be found, for example, in WO 2021 182 779 A1, EP 3 800 702 A1, or EP 3 790 075 A1. Material usage when such bus bars are produced as stamped parts or cut parts is small in the case of contacting connectors branching off at a 90° angle. In addition, in the case of a hexagonal arrangement of the battery cells, also called a cell pack, which affords the best use of space for example in the case of cylindrical battery cells, the electrical connection distance between battery cells connected in series is relatively large such that the resistance between the latter is also unnecessarily large. If a cylindrical battery cell comprises a terminal on its end side in the region of its flanged edge, the electrical contacting of this flanged edge via a contacting connector extending perpendicularly from the base body allows only very small positional tolerances of the battery cell relative to the main direction of extent, i.e. in the direction of a row of battery cells connected in parallel.

### DESCRIPTION OF THE INVENTION

Starting from the known prior art, an object of the present invention is to provide an improved bus bar for contacting preferably cylindrical battery cells accommodated in a cell holder to form a battery module of a high-voltage battery, preferably of a traction battery for a vehicle, and a corresponding battery module arrangement for forming a high-voltage battery, preferably a traction battery for a vehicle, and a method for connecting a bus bar to a cell contact of a battery cell.

The object is solved by a bus bar for contacting preferably cylindrical battery cells accommodated in a cell holder to form a battery module of a high-voltage battery, preferably of a traction battery for a vehicle, having the features of claim 1. Advantageous developments can be found in the dependent claims, the description, and the Figures.

Accordingly, a bus bar for contacting preferably cylindrical battery cells accommodated in a cell holder to form a battery module of a high-voltage battery, preferably of a traction battery for a vehicle, is suggested which comprises a base body extending in a main direction of extent and at least one contacting connector, designed as a single piece with the base body, for contacting a cell contact of one of the battery cells.

The bus bar is moreover designed in such a way that the contacting connector extends in a connecting direction of extent which encloses a connecting angle with the main direction of extent of between 0° and less than 90°, wherein the bus bar preferably has a plurality of abovementioned contacting connectors.

The term “connecting angle” is understood to mean the angle which is enclosed by the projection of the connecting direction of extent and the projection of the main direction of extent onto a plane in which the base body extends. In the case of a base body made, for example, from a (metal) sheet, the plane is defined by the two-dimensional extent of the sheet/base body and therefore perpendicular to the direction of the thickness of the sheet/base body.

Because the contacting connector extends in a connecting direction of extent which encloses a connecting angle of between 0° and less than 90° with the main direction of extent, particularly high material usage in the production of the bus bar can be obtained, in particular when the latter is stamped as a stamped part or cut as a cut part from a (metal) sheet. This is because the contacting connectors consequently bear closely against the base body, in contrast to conventional bus bars described in the prior art with contacting connectors extending perpendicularly to the main direction of extent.

In particular in the case of a hexagonal arrangement of preferably cylindrical battery cells in a battery module which enables particularly high use of space, the electrical connection distance between two battery cells connected in series by the bus bar can moreover be kept particularly short, even kept as short as possible, and accordingly the electrical resistance can thus be kept particularly low, even kept as low as possible.

Such a design of the bus bar moreover allows the coverage of the upper side of the battery cells by the cell holder and bus bar to be minimized such that particularly effective venting, or even venting which is essentially not prevented by the bus bar, of the battery cell or cells is enabled in the event of a fault.

If the contacting connector for contacting a cell contact, arranged in the region of the circumference of an end side of a cylindrical battery cell and therefore at its flanged edge, which can be designed, for example, as a negative terminal of the battery cell is provided, a high positional tolerance in terms of the position of the bus bar and hence of the contacting connector, on the one hand, and of the battery cell, on the other hand, in the main direction of extent can be obtained. If the main direction of extent is arranged in the direction of a parallel connection of battery cells, this enables correspondingly larger positional tolerances of the battery cells connected in parallel in the main direction of extent and hence spacings between the battery cells in the main direction of extent which vary, for example, because of manufacturing tolerances of the cell holder. Because there is no difference in potential between battery cells connected in parallel, generally higher tolerances in this spatial direction are possible than in the case of battery cells with a variable difference in potential and battery cells connected in series. The abovementioned permitted tolerances in the direction of a parallel connection can accordingly be better exploited by the design of the contacting connector with the connecting angle compared with conventional bus bars with perpendicularly branching contacting connectors. The bus bar according to the invention therefore allows simpler and more robust (batch) production, a simpler structure, and lower material usage in terms of the bus bar itself than in particular in terms of the cell holder and the battery module arrangement.

There is no disadvantage in a possible accompanying relatively low positional tolerance in the direction in which battery cells are connected in series by the bus bar, transversely to the main direction of extent, because a narrow tolerance needs to be provided here anyway structurally in order to maintain the air gaps and creepage distances.

The connecting direction of extent is preferably oriented, or the contacting connector extending in the connecting direction of extent extends, in such a way that contacting of the cell contact to be contacted by this contacting connector is achieved tangentially to a center axis of the battery cell having the cell contact. A relatively high possible positional tolerance in terms of the bus bar relative to the battery cells to be contacted and between the battery cells relative to one another can thus be provided.

The main direction of extent is preferably oriented in the main load direction, i.e. in the direction in which a plurality of battery cells are connected in parallel.

The base body has in its main direction of extent a length which is many times greater than its width transverse to the main direction of extent. In other words, the base body can be designed as a strip or web. The elongated “bar” shape of the bus bar results therefrom.

According to a further preferred embodiment, the connecting angle α is less than 45°, preferably less than 40°, particularly preferably less than 35°, particularly preferably less than 30°, wherein the connecting angle is preferably 25°, 20°, 15°, 10°, 5°, or 0°. The smaller the connecting angle, the larger the available positional tolerances in the main direction of extent. In addition, as the connecting angle decreases, the potential degree of material usage increases, for example when the busbar is sheared/cut from a piece of sheet metal. Moreover, the length of a current path provided via the bus bar between two battery cells connected in series can be designed as shorter the smaller the connecting angle. As the connecting angle increases, the spacing between two rows of battery cells transverse to the main direction of extent can be larger, and/or the width of the base body can be designed as smaller such that material can be saved with respect to the bus bar itself. A variety of tests have surprisingly shown that particularly favorable combinations of the above advantages can be obtained in an angle of inclination range of 0° to 45°, in particular at 0° and 25°.

It has proved to be advantageous if the contacting connector extends in the form of a tab in the connecting direction of extent from the side of the main body with reference to the main direction of extent. In other words, the at least one contacting connector is provided on the side of the base body relative to the main direction of extent.

According to a further preferred embodiment, the bus bar comprises at least one first contacting connector for contacting a cell contact of a first polarity of a first battery cell and at least one second contacting connector for contacting a cell contact of the second polarity of a second battery cell. The bus bar preferably comprises a plurality of first and/or second contacting connectors.

Relative to the main direction of extent, the at least one first contacting connector is arranged on a first side of the base body and the at least one second contacting connector is arranged on a second side of the base body.

It has proved to be advantageous if the first contacting connector is designed to contact a cell contact of a first polarity arranged centrally on an end side of a battery cell and/or if the second contacting connector is designed to contact a cell contact of a second polarity arranged in the circumferential region on the end side of a further battery cell.

According to a further preferred embodiment, the first contacting connector extends in a first direction from the base body relative to the main direction of extent and the second contacting connector extends from the base body in a second direction oriented counter to the first direction relative to the main direction of extent.

The phrase “direction relative to the main direction of extent” here means that this direction comprises at least one component which runs in the main direction of extent. The direction corresponds to a vector, starting at the base or foot or root section of the contacting connector on the base body and extends in the direction of the free end of this contacting connector. In other words, the direction can be determined as the component of the connecting direction of extent which is parallel to the main direction of extent. In particular in the case of a hexagonal arrangement of the battery cells in the cell holder or battery module, a particularly short current path between two battery cells connected in series can thus be obtained.

According to a further preferred embodiment, relative to a transverse direction arranged perpendicularly to the main direction of extent, the first contacting connector extends from the base body in a first direction and the second contacting connector extends from the base body in a second direction oriented counter to the first direction. The base body can thus be designed with a relatively small width and the material requirement for the bus bar can thus be relatively small.

According to a further preferred embodiment, a root section of the first contacting connector, from which the first contacting connector extends from the base body, and a root section of the second contacting connector, from which the second contacting connector extends from the base body, are arranged essentially at the same height relative to the main direction of extent. A particularly short current path can thus be obtained between two battery cells connected in series by means of the bus bar.

“Essentially at the same height” is defined for this purpose as lying within predetermined tolerances within which the offset of the root sections, more precisely from the centers, is in the main direction of extent less than or equal to the width of the tabs transverse to their connecting direction of extent.

According to a further preferred embodiment, in a state before contacting the cell contacts to be contacted, the base body and the contacting connectors are designed as a one-piece, i.e. integral, two-dimensional sheet-metal part. The bus bar preferably constitutes a two-dimensional sheet-metal part before contacting the cell contacts to be contacted.

According to a further preferred embodiment, the at least one contacting connector has a contacting section for contacting a cell contact and in each case one deformation section via which, when the contacting section is pushed down in the direction of the thickness of the base body from the height level of the base body to a different height level of the cell contact to be contacted in order to contact the cell contact, a deformation, preferably an elastic and/or plastic deformation, preferably comprising bending, can be absorbed. The bus bar can thus be designed as a two-dimensional sheet-metal part, wherein deformation of the at least one contacting connector for producing physical contact with the cell contact to be contacted, and contacting in the sense of forming a permanent electrically conductive connection between the contacting connector and the cell contact, can take place in one working step.

According to a further preferred embodiment, the base body comprises a transition section in an S-shaped curve between two connecting regions from which in each case at least one contacting connector extends, wherein the connecting regions preferably in each case have a predetermined width transverse to the main direction of extent and the transition section has a width transverse to the which is smaller than the width of the connecting regions, wherein the transition section preferably has a length in the main direction of extent which is greater than the length of two contacting connectors in the main direction of extent. The bus bar can thus be designed in a particularly material-saving fashion because, by virtue of the S-shaped curve, the base body comprises regions where material has been omitted and in which in each case a contacting connector can extend at its respective connecting angle, preferably 0° in order to contact a cell contact in the circumferential region or 25° in order to contact a centrally arranged cell contact, without significantly increasing the overall width of the bus bar.

A connecting region preferably comprises in each case a first and a second contacting connector.

The object set above is furthermore achieved by a battery module arrangement for forming a high-voltage battery, preferably a traction battery for a vehicle, having the features of claim 10. Advantageous developments can be found in the present description and the Figures.

Correspondingly, a battery module arrangement for forming a high-voltage battery, preferably a traction battery for a vehicle, is proposed which comprises a cell holder, a plurality of battery cells accommodated in the cell holder, and a bus bar according to one of the above embodiments.

The advantages and effects described with respect to the bus bar can be obtained in a similar fashion by the battery module arrangement, for which reason a further description thereof has been omitted in order to avoid redundancy.

The object set above is furthermore solved by a method for connecting a bus bar to a cell contact of a battery cell in a battery module arrangement having the features of claim 11. Advantageous developments of the method can be found in the dependent claims and the present description and the Figures.

Correspondingly, a method for connecting a bus bar to a cell contact of a battery cell is proposed which comprises assembling a cell holder for accommodating battery cells in a battery module to a bus bar according to one of the above embodiments, holding down the bus bar with at least one hold-down device, pressing on a contacting connector of the bus bar in order to contact a battery cell accommodated in the cell holder, and welding the contacting connector to the battery cell.

The advantages and effects described with respect to the bus bar are obtained in a similar fashion by the method.

In particular, the method, preferably in conjunction with a correspondingly designed supporting geometry at the cell holder, makes it possible to effect the bending of the contacting connector or connectors downward as far as the contact surface of the cell contact to be contacted in each case in the same process step as the electrical contacting, preferably by laser or ultrasound welding.

By virtue of the manufacture of the bus bar as a purely two-dimensional stamped part or cut part instead of a three-dimensionally shaped stamped and bent part as is the case in conventional methods, the production, the handling, and especially the placing of the bus bar on the cell holder, and the tolerances which have to be observed in this regard can be enabled without inadvertent electrical contacting of the cells before the actual welding process.

According to a further preferred embodiment, in the pressing step a contacting section of the contacting connector is pressed out of a plane defined by the base body of the bus bar and against the cell contact to be contacted of the battery cell, wherein a deformation section of the contacting connector preferably experiences elastic and/or plastic deformation.

According to a further preferred embodiment, the pressing of the contacting connector against a battery cell is effected by means of a welding head which is likewise used for the immediately subsequent welding of the contacting connector and the cell contact.

In other words, the pressing, preferably with the deformation of the contacting connector, preferably of its deformation section, from the plane defined by the base body, both down and against the cell contact of the battery cell to be contacted is effected in a step with the welding of the contacting connector and the cell contact by a single tool designed for this purpose. The welding head is therefore designed to press on the contacting connector and to weld the contacting connector to the cell contact.

### SHORT DESCRIPTION OF THE FIGURES

Preferred further embodiments of the invention are explained in detail by the following description of the Figures, in which:

FIG. 1 shows schematically a plan view of a battery module arrangement for forming a high-voltage traction battery of a vehicle;

FIG. 2 shows schematically a detailed view of the plan view in FIG. 1;

FIG. 3 shows schematically a perspective side view of the battery module arrangement according to FIGS. 1 and 2 during its production;

FIG. 4 shows schematically a perspective side view of the battery module arrangement according to FIGS. 1 to 3 during its production; and

FIG. 5 shows schematically a further perspective side view of the battery module arrangement in FIG. 4.

### DETAILED DESCRIPTION OF PREFERRED EXEMPLARY EMBODIMENTS

Preferred exemplary embodiments will be described below on the basis of the Figures. The same or similar elements or those having the same effect are here provided in the various Figures with identical reference signs and repeated description of these elements will sometimes be dispensed with in order to avoid redundancy.

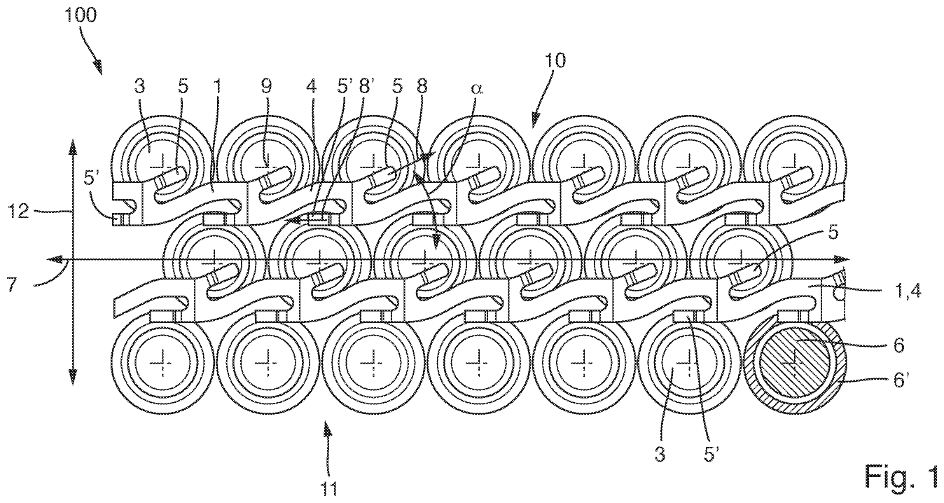

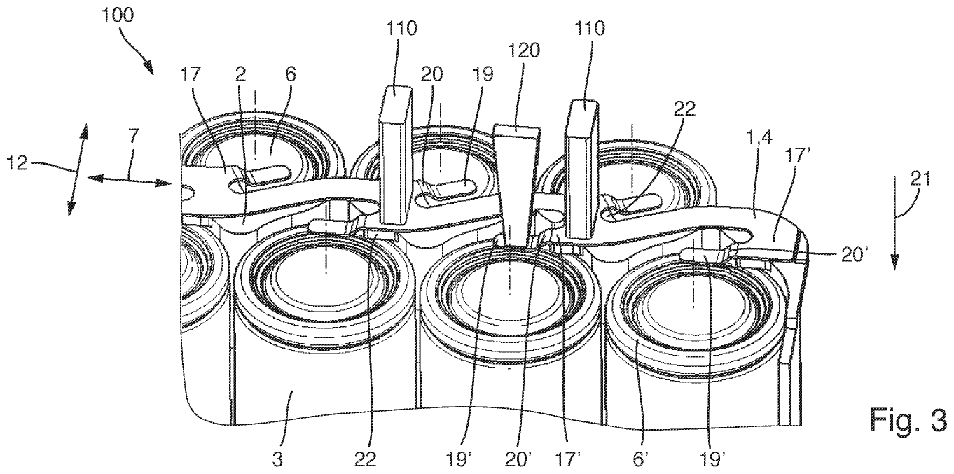

A plan view of a battery module arrangement 100 for forming a high-voltage traction battery of a vehicle is shown schematically in FIG. 1. It comprises a cell holder (see reference sign 2 in FIGS. 3 to 5) which is not shown here for reasons of clarity and has a plurality of sockets in which in each case a cylindrical battery cell 3 is received. The sockets of the cell holder 2 are arranged in such a way that the battery cells 3 are arranged in a hexagonal pattern perpendicular to the (longitudinal) center axes 9 of the latter. They therefore constitute a hexagonal cell pack.

The battery module arrangement 100 moreover comprises a plurality of bus bars 1 which run in parallel and are designed to contact a plurality of battery cells 3 accommodated in the cell holder 2.

The bus bar 1 comprises a base body 4 which extends in a main direction of extent 7 and a plurality of contacting connectors 5, 5′, designed as a single piece with the base body 4, for contacting in each case one cell contact 6, 6′ of in each case one battery cell 3.

The main direction of extent 7 corresponds to a direction in which battery cells are arranged in a row one behind the other. They are connected in parallel by the bus bar 1, as explained in detail below.

The contacting connectors 5, 5′ are divided into a plurality of first contacting connectors 5 for contacting in each case one cell contact 6 of a first polarity of in each case one battery cell 3, here the positive terminal cell contact 6 arranged centrally on that end side of the respective battery cell 3 which can be seen in the plan view in FIG. 1, and into a plurality of second contacting connectors 5′ for contacting a cell contact 6′ of the second polarity of in each case one battery cell 3, here the negative terminal cell contact 6′ arranged in the circumferential region on the end side of the respective battery cell 3.

As can be seen in FIG. 1, relative to the main direction of extent 7, the first contacting connectors 5 are arranged on the side of the base body 4, on a first side 10 of the base body 4, and the second contacting connectors 5′ are arranged on the side of the base body 4, on the other (second) side 11 of the base body 4.

Correspondingly, the main direction of extent 7 corresponds to the main load direction, i.e. the direction in which a plurality of battery cells 3 are connected in parallel. Put differently, a plurality of battery cells 3 arranged in the main direction of extent 7 are connected electrically in parallel by the first contacting connectors 5 by contacting in each case their positive terminal cell contact 6 in the main direction of extent 7 on the first side 10 of the base body 4, and a further plurality of battery cells 3 arranged in the main direction of extent 7 are connected electrically in parallel by contacting in each case their negative terminal cell contact 6′.

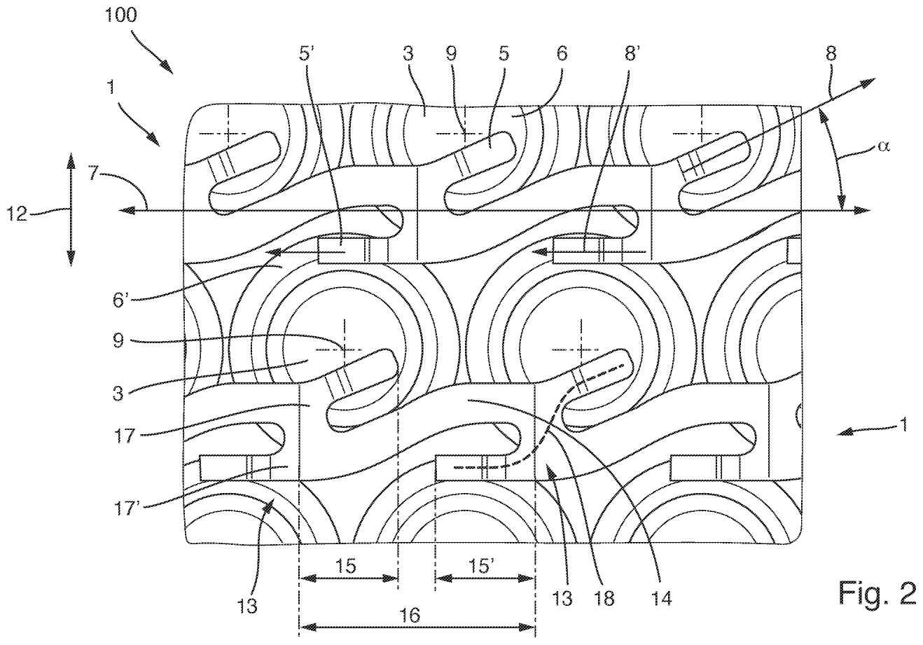

In a transverse direction 12 oriented perpendicularly to the main direction of extent 7, in each case two battery cells 3 are electrically connected in series by in each case a first contacting connector 5 and a second contacting connector 5′, as explained in detail with reference to FIG. 2.

The contacting connectors 5, 5′ extend in each case in a contacting direction of extent 8, 8′ which encloses a connecting angle a of between 0° and less than 90° with the main direction of extent 7.

In the present case, the first contacting connectors 5 have a connecting direction of extent 8 which is oriented at a connecting angle α of 25° relative to the main direction of extent 7. The second contacting connectors moreover have a connecting direction of extent 8′ which is oriented parallel to the main direction of extent 7 and therefore at a connecting angle of 0°.

The connecting angles a of the first and second contacting connectors 5, 5′ are therefore different. Alternatively, they can also have the same connecting angle α.

A detailed view of the plan view from FIG. 1 is shown schematically in FIG. 2. As can be seen with respect to the connecting directions of extent 8, 8′ indicated in the top right of FIG. 2, the first contacting connectors 5 and their connecting direction of extent 8 extend from the base body 4 in a first direction relative to the main direction of extent 7. Moreover, the second contacting connectors 5′ extend from the base body 4 in a second direction oriented counter to the first direction relative to the main direction of extent 7 and their connecting directions of extent 8′.

The base body 4 of each bus bar 1 can be considered to be split essentially into two regions or sections, namely a connecting region 13 and a transition section 14, which alternate in the main direction of extent 7. A transition section 14 with an S-shaped curve is in each case arranged between two connecting regions 13 from which in each case a first contacting connector 5 and a second contacting connector 5′ extend. The connecting regions 13 have a predetermined width transverse to the main direction of extent 7 (i.e. in the transverse direction 12). The transition sections 14 moreover have a width transverse to the main direction of extent 7 which is less than the width of the connecting regions 13. In the present case, a length 16 of the transition sections 14 in the main direction of extent 7 is greater than the sum of the length 15 of the first contacting connector 5 and the length 15′ of the second contacting connector 5′ in the main direction of extent 7.

The bus bar 1 and its base body 4 consequently have socket regions with no material in which in each case a contacting connector 5, 5′ can extend.

The contacting connectors 5, 5′ are designed in the form of a tab. They extend, starting from a root section 17, 17′ with which they are joined as a single piece to the base body 4, in the direction of their connecting direction of extent 8, 8′. With reference to a connecting region 13, the root sections 17, 17′ of the pair of the first and second contacting connectors 5, 5′ which extend there are arranged essentially at the same height with reference to the main direction of extent 7. A particularly short current path 18 between two battery cells 3 connected in series thus results.

As can be seen in FIG. 2, the connecting directions of extent 8, 8′ of the contacting connectors 5, 5′ are oriented in such a way, or the latter extend in the connecting direction of extent 8, 8′ in such a way, that contacting of the cell contact 6, 6′ to be contacted by this contacting connector 5, 5′ is achieved tangentially to a center axis 9 of the respective battery cell 3 having the cell contact 6, 6′.

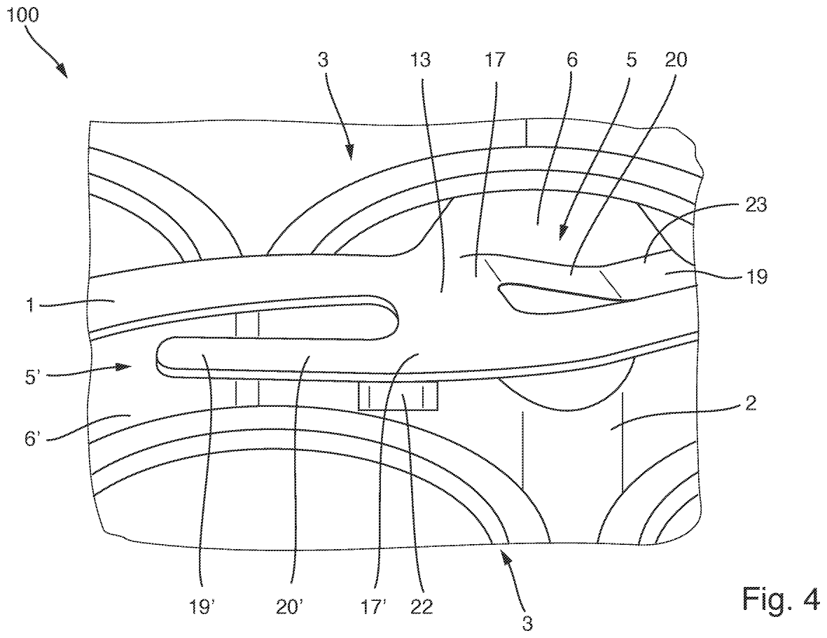

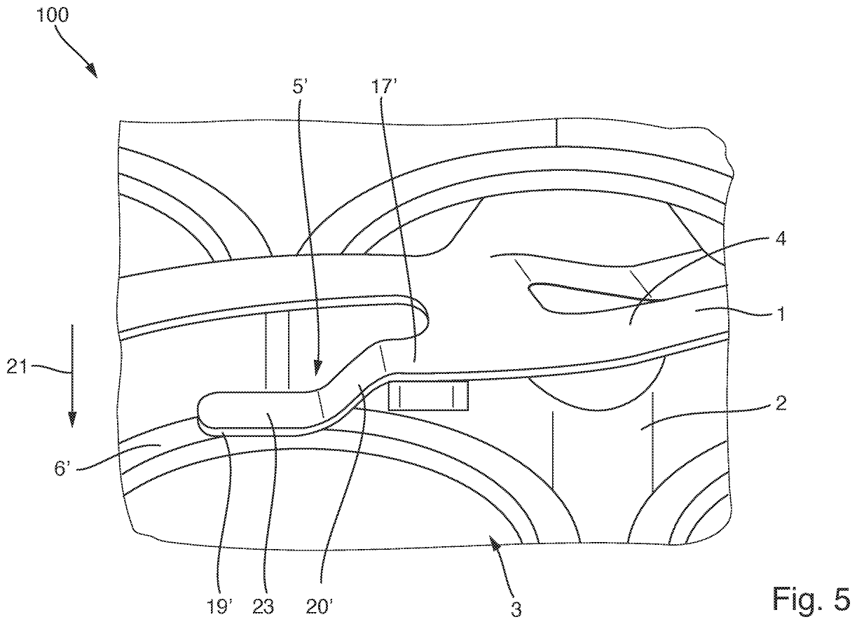

FIG. 3 shows schematically a perspective side view of a subregion of the battery module arrangement 100 according to FIGS. 1 and 2. Two hold-down devices 110 and a welding head 120 are shown schematically by way of example. The hold-down devices 110 here, by way of example, hold down the bus bar 1 and, put differently, press it onto the cell holder 2 illustrated here. As a result, the bus bar 1 is retained in a fixed position relative to the cell holder 2 and thus to the battery cells 3 held therein such that the welding head 120 can weld a contacting connector 5, 5′ to one of the battery cells 3. The bus bar 1 produced from flat material, to be more precise its respective contacting connector 5, 5′, is here pressed down and welded by the welding head 120 onto the contacting surface of the cell contact 6, 6′ of the respective battery cell 3, as illustrated again with reference to FIGS. 4 and 5. The welding is sufficient to retain the bus bar 3 and to provide sufficient contacting.

The first contacting connectors 5 situated behind in perspective in FIG. 5 are here illustrated by way of example as being already cold-welded, and the second contacting connectors 5′ situated in front in perspective are here illustrated by way of example in a partially pressed-down position. A welding head 120 is here shown only by way of example when a second contacting connector 5′ is being pressed down before the actual welding. One or more contacting connectors 5, 5′ can, for example, be pressed down, or respectively welded, at the same time.

In a state before the contacting of the cell contacts 6, 6′ to be contacted, the bus bar 1 is designed as an integral two-dimensional sheet-metal part.

The contacting connectors 5, 5′ have in each case a contacting section 119 for contacting a cell contact 6, 6′ and in each case a deformation section 20, 20′, wherein the latter experiences a deformation, preferably an elastic and/or plastic deformation, in particular bending, when the contacting section 19 is depressed by the welding head 120 in a direction of the thickness 21 of the base body 4 from the height level (in the direction of thickness 21) of the base body 4 to a different height level (in the direction of thickness 21) of the cell contact 6, 6′ to be contacted in order to contact this cell contact 6, 6′.

In order to nurture an intended deformation precisely in the deformation region 20, 20′ provided therefor, the cell holder 2 optionally has a support region 22 on which the contacting connector 5, 5′ to be pressed is supported with its root region.

FIG. 4 shows a further perspective side view of the battery module arrangement according to the previous Figures. In this FIG. 4, a connecting region 13 of the bus bar 1 is shown with a first contacting connector 5 on the first side 10 and a second contacting connector 5′ on the second side 11.

The first contacting connector 5 is present in an already contacted state with the cell contact 6. The weld point 23 can be seen accordingly.

The second contacting connector 5′ is still present in its two-dimensional state, i.e. before it is pressed down and welded by the welding head 120 (see FIG. 3) in a manufacturing step. Correspondingly, the sections 19′ and 20′ have also not yet been formed as such and instead are provided within the two-dimensional tab.

FIG. 5 shows the perspective side view from FIG. 4, wherein the second contacting connector 5′ has been pressed from the plane defined by the base body 4 via the welding head 120 (see FIG. 3) against the negative terminal cell contact 6′ and welded. Correspondingly, the deformation section 20′ extends in the direction of thickness 21 from the height level of the base body 4 to the height level of the cell contact 6′. The contacting section 19′ moreover then correspondingly likewise comprises a weld point 23 such that the contacting connector 5′ is connected permanently to the cell contact 6′ in a current-conducting fashion.

Where applicable, all the individual features which are illustrated in the exemplary embodiments can be combined with one another and/or interchanged without departing from the scope of the invention.

### LIST OF REFERENCE SIGNS

1 bus bar
2 cell holder
3 battery cell
4 base body
5, 5′ contacting connector
6, 6′ cell contact
7 main direction of extent
8, 8′ connecting direction of extent
9 center axis
10 first side
11 second side
12 transverse direction
13 connecting region
14 transition section
15, 15′ length
16 length
17, 17′ root section
18 current path
19, 19′ contacting section
20, 20′ deformation section
21 direction of thickness
22 support region
23 weld point
100 battery module arrangement
110 hold-down device
120 welding head

1. A bus bar (1) for contacting preferably cylindrical battery cells (3) accommodated in a cell holder (2) in order to form a battery module (100) of a high-voltage battery, preferably of a traction battery for a vehicle, comprising a base body (4) extending in a main direction of extent (7) and at least one contacting connector (5, 5′), designed as a single piece with the base body (4), for contacting a cell contact (6) of one of the battery cells (3),
characterized in that
the contacting connector (5, 5′) extends in a connecting direction of extent (8, 8′) which encloses a connecting angle (a) with the main direction of extent (7) of between 0° and less than 90°.

2. The bus bar (1) as claimed in claim 1, characterized in that the connecting angle (α) is less than 45°, preferably less than 40°, particularly preferably less than 35°, particularly preferably less than 30°, wherein the connecting angle is preferably 25°, 20°, 15°, 10°, 5°, or 0°, and/or in that the contacting connector extends in the form of a tab in the connecting direction of extent (8, 8′) from the side of the main body with reference to the main direction of extent.

3. The bus bar (1) as claimed in one of the preceding claims, characterized in that the bus bar (1) comprises a first contacting connector (5) for contacting a cell contact (6) of a first polarity and a second contacting connector (5) for contacting a cell contact (6′) of the second polarity, wherein, preferably relative to the main direction of extent (7), the first contacting connector (5) is arranged on a first side of the base body (4) and the second contacting connector (5′) is arranged on a second side of the base body (4), wherein preferably the first contacting connector (5) is designed to contact a cell contact (6) of a first polarity arranged centrally on an end side of a battery cell (3) and/or the second contacting connector (5′) is designed to contact a cell contact (6′) of a second polarity arranged in the circumferential region on the end side of a further battery cell (3).

4. The bus bar (1) as claimed in the preceding claim, characterized in that the first contacting connector (5) extends in a first direction from the base body (4) relative to the main direction of extent (7) and the second contacting connector (5′) extends from the base body (4) in a second direction oriented counter to the first direction relative to the main direction of extent (7).

5. The bus bar (1) as claimed in one of the preceding claims, characterized in that, relative to a transverse direction (12) arranged perpendicularly to the main direction of extent (7), the first contacting connector (5) extends from the base body (4) in a first direction and the second contacting connector (5′) extends from the base body (4) in a second direction oriented counter to the first direction, relative to the main direction of extent (7).

6. The bus bar (1) as claimed in one of the preceding claims, characterized in that a root section (17) of the first contacting connector (5), from which the first contacting connector (5) extends from the base body (4), and a root section (17′) of the second contacting connector (5′), from which the second contacting connector (5′) extends from the base body (4), are arranged essentially at the same height relative to the main direction of extent (7).

7. The bus bar (1) as claimed in one of the preceding claims, characterized in that, in a state before contacting the cell contacts (6, 6′) to be contacted, the base body (4) and the at least one contacting connector (5, 5′) are designed as an integral, two-dimensional sheet-metal part.

8. The bus bar (1) as claimed in one of the preceding claims, characterized in that the at least one contacting connector (5, 5′) has a contacting section (19, 19′) for contacting a cell contact (6, 6′), and a deformation section (20, 20′) via which, when the contacting section (19, 19′) is pushed down in the direction of the thickness (21) of the base body (4) from the height level of the base body (4) to a different height level of the cell contact (6, 6′) to be contacted in order to contact the cell contact (6, 6′), a deformation, preferably an elastic and/or plastic deformation, preferably bending, can be absorbed.

9. The bus bar (1) as claimed in one of claims 3 to 8, characterized in that the base body (4) comprises a transition section (14) in an S-shaped curve between two connecting regions (13) from which in each case at least one contacting connector (5, 5′) extends, wherein the connecting regions (13) preferably have a predetermined width transverse to the main direction of extent (7) and the transition section (14) has a width transverse to the which is smaller than the width of the connecting regions (13), wherein the transition section (14) preferably has a length in the main direction of extent (7) which is greater than the length of two contacting connectors (5, 5′) in the main direction of extent (7).

10. A battery module arrangement (100) for forming a high-voltage battery, preferably a traction battery for a vehicle, comprising a cell holder (2), a plurality of battery cells (3) accommodated in the cell holder (2), and a bus bar (1) as claimed in one of the preceding claims.

11. A method (40) for connecting a bus bar (1) to a cell contact (6, 6′) of a battery cell (3), comprising
assembling a cell holder (2) for accommodating battery cells (3) in a battery module (100) to a bus bar (1) as claimed in one of the preceding claims;
holding down the bus bar (1) with at least one hold-down device (110);
pressing on a contacting connector (5,5′) of the bus bar (1) in order to contact a battery cell (3) accommodated in the cell holder (2); and
welding the contacting connector (5, 5′) to the battery cell (3).

12. The method as claimed in the preceding claim, characterized in that in the pressing step a contacting section (19, 19′) of the contacting connector (5, 5′) is pressed out of a plane defined by a base body (4) of the bus bar (1) and against the cell contact (6, 6′) to be contacted, wherein a deformation section (20, 20′) of the contacting connector (5, 5′) preferably experiences elastic and/or plastic deformation.

13. The method as claimed in claim 11 or 12, characterized in that the pressing of the contacting connector (5, 5′) against the battery cell (3) is effected by means of a welding head (120).
